(19) United States
(12) Patent Application Publication
(10) Pub. No.: US 2025/0392462 A1
(43) Pub. Date: Dec. 25, 2025

(54) SYSTEM AND METHOD FOR PROVIDING A SECURE ACCESS TO A WEBPAGE

(71) Applicant: SECRET DOUBLE OCTOPUS LTD, Tel-Aviv (IL)

(72) Inventor: Shimrit TZUR-DAVID, Mevaseret Zion (IL)

(73) Assignee: SECRET DOUBLE OCTOPUS LTD, Tel-Aviv (IL)

(21) Appl. No.: 18/751,419

(22) Filed: Jun. 24, 2024

(51) Int. Cl. H04L 9/32; H04L 9/08; H04L 67/55

(52) U.S. Cl. CPC H04L 9/3213; H04L 9/0825; H04L 9/3228; H04L 67/55

(57) ABSTRACT

A computer-based system and method for providing a secure access to a webpage, including: obtaining, at an authentication server from a user agent application, a request to open the webpage provided by a web server, together with a username; generating a token by the authentication server; providing, by the authentication server, the token to the user agent application and to the web server; sending, by the user agent application, a request to open the webpage together with the token to the web server; verifying, by the web server, the token obtained from the user agent application against the token obtained from the authentication server; and opening the webpage by the web server upon successful verification.

### FIELD OF THE INVENTION

The present invention relates generally to providing a secure access to a webpage, for example using a security object such as a token.

### BACKGROUND

A phishing attack may refer to an attempt to steal sensitive information by an attacker masquerading as a trusted entity such as a bank or other organization that holds sensitive data. For example, the attacker may mislead a victim into opening an email, instant message, or text message and clicking a malicious link leading to a fake webpage appearing exactly like a real webpage of the trusted entity. The attacker, operating and monitoring the fake page, may request the user to enter his credentials, e.g., username and password. Once the user types this data into the fake webpage, the attacker may hijack the user credentials and use them to enter the user's account on the real trusted entity.

Phishing attacks can have devastating results. For individuals and organizations, this may include unauthorized purchases, the stealing of funds, identify theft or stealing sensitive information. Therefore, a method for preventing phishing attacks is required.

### SUMMARY

According to embodiments of the invention, a computerized system and method for providing a secure access to a webpage may include obtaining, at an authentication server from a user agent application, a request to open the webpage provided by a web server, together with a username; generating a token by the authentication server; providing, by the authentication server, the token to the user agent application and to the web server; sending, by the user agent application, a request to open the webpage together with the token to the web server; verifying, by the web server, the token obtained from the user agent application against the token obtained from the authentication server; and opening the webpage by the web server upon successful verification.

Embodiments of the invention may include signing the token by the user agent application using a private key owned by the user agent application prior to providing the token to the web server, where sending, by the user agent application, the token to the web server may include sending the signed token, where the web server may verify the signed token obtained from the user agent application against the token obtained from the authentication server using a public key corresponding to the private key.

Embodiments of the invention may include authenticating the user by the authentication server prior to generating the token.

According to embodiments of the invention, authenticating the user by the authentication server may include: sending, by the authentication server, a push notification to the user via a user device; and obtaining, at the authentication server, a user confirmation from the user device.

Embodiments of the invention may include operating a web browser by the user agent application.

Embodiments of the invention may include providing the webpage to the user through the web browser.

According to embodiments of the invention, providing the webpage may include: sending, by the authentication server to the web browser, a single sign-on (SSO) token; using the SSO token to authenticate the user; and opening the webpage via the web browser, upon successful verification of the SSO token.

According to embodiments of the invention, providing the webpage may include: sending, from the authentication server to the web browser, a single sign-on (SSO) token; sending, from the web browser to the authentication server, a request for executing the webpage; sending, from the web browser to the authentication server; the SSO token; authenticating the user, by the authentication server, using the SSO token; sending, from the authentication server to the web browser, a corresponding URL for the required webpage, upon successful verification of the user; sending from the web browser, a request to open the URL to the web server; forwarding the request to a verification service; verifying the SSO token by the verification service; and opening the webpage by the web server via the web browser, upon successful verification of the SSO token.

According to embodiments of the invention, the token may be valid for a limited period.

According to embodiments of the invention, a computerized system and method for providing a secure access to a webpage, the method may include: obtaining, in a user agent application, a request to open a webpage; sending, by the user agent application, the request to open the web portal to an authentication server, together with a username; generating a token by the authentication server; sending, by the authentication server, the token to the user agent application; sharing, by the authentication server, the token with a portal server; signing the token by the user agent application using a private key owned by the user agent application; sending, by the user agent application, the signed token together with an address of the webpage to the portal server; verifying, by the portal server, the signed token against the shared token using a public key corresponding to the private key; and opening the webpage by the portal server upon successful verification.

According to embodiments of the invention, sharing, by the authentication server, the token with a portal server may include: storing, by the authentication server, the token in a database common to the authentication server and to a portal server; and reading, by the portal server, the token from the common database.

### BRIEF DESCRIPTION OF THE DRAWINGS

The subject matter regarded as the invention is particularly pointed out and distinctly claimed in the concluding portion of the specification. Embodiments of the invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 depicts a system according to embodiments of the invention;

FIG. 2 is a flowchart of a method for providing a secure access to a webpage, according to embodiments of the invention;

FIG. 3 is a flowchart of a method for providing secure access to a webpage with added levels of protection, according to embodiments of the invention;

FIG. 4 depicts a system according to embodiments of the invention;

FIG. 5 is a flowchart of a method for providing a secure access to a webpage through a portal server, according to embodiments of the invention; and

FIG. 6 illustrates an example computing device according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device that manipulates and/or transforms data represented as physical (e.g., electronic) quantities within the computer's registers and/or memories into other data similarly represented as physical quantities within the computer's registers and/or memories or other information transitory or non-transitory or processor-readable storage medium that may store instructions, which when executed by the processor, cause the processor to execute operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items unless otherwise stated. Unless explicitly stated, the method embodiments described herein are not constrained to a particular order or sequence. Additionally, some of the described method embodiments or elements thereof can occur or be performed in a different order from that described, simultaneously, at the same point in time, or concurrently.

Various methods known in the art are aimed at preventing phishing attacks. Multi-factor authentication (MFA) is a popular authentication method that requires the user to provide two or more verification factors on top of the username, for example one or more of a pin code, a biometric factor or a password and a one-time password (OTP). The user may typically receive the OTPs via email, SMS or a mobile application, and may be required to provide the OTP as part of a legitimate login process. However, MFA may not provide sufficient protection against some phishing attacks, for example dynamic phishing attacks. In a dynamic phishing attack, the fake webpage, after obtaining the username of the user, may use the username to login into the trusted entity, the trusted entity may send the OTP to the user in whichever way that is supported by the legitimate application, and the user, expecting the OTP, may provide the OTP to the fake webpage. Thus, the attacker may get the OTP from the user as well and use it to complete the login process.

In another example, the trusted entity may authenticate the user following a login request by sending a push notification message (e.g., a message initiated by a server) to a user device (such as a mobile phone of the user) and requesting the user to approve the request via an application on the user device. In a dynamic phishing attack, the fake webpage, after obtaining the username of the user, may use the username to login into the trusted entity, the trusted entity may send the push notification message to the user, and the user, expecting the push notification message, may approve the push notification message. Thus, the attacker may login into the trusted webpage without even having to obtain an OTP.

In another example, the attacker may use the username of the user to login into the trusted entity without the user trying to login to the fake web page. The trusted entity may send the push notification message to the user, and the user, accidently, may approve the push notification message. Thus, the attacker may login into the trusted webpage without even having to obtain an OTP or creating a fake webpage.

Typically, webpage or a website is stored and operated by a web server. When a client device, referred herein also as a local device) wants to access or open a webpage, a copy of the webpage may be downloaded from the server onto the client device and displayed in a web browser of the client device. Embodiments of the invention may provide a secure access to a webpage or a website, using a security object such as a token (e.g., an alphanumeric sequence or other data object) that is sent (e.g., via direct link, a network or provided through a common or shared database) from an authentication server to the web server or portal server and to a client device. According to embodiments of the invention, the requested webpage or website may open (e.g., downloaded and display on a client device) only after verification of the token sent to the client device against the token sent to the web server or portal server. Thus, a request for opening the webpage or website that is sent to the web server or portal server without the token may not be served. For example, a request obtained from an attacker after a successful phishing attempt, e.g., from an attacker that has succeeded in stilling the credentials and the MFA factors, e.g., an OTP, of the user, or if the user has approved an authentication message that was sent to the user device 120 (depending on the verification method used by the legitimate webpage or a website, may not be served, since the attacker may not have access to the token and may not be able to provide the token to the webpage. Therefore, embodiments of the invention may improve the technology of protecting against phishing attempts and possible other illegitimate usage of stolen user credentials, by preventing access to the requested webpages from the attacker.

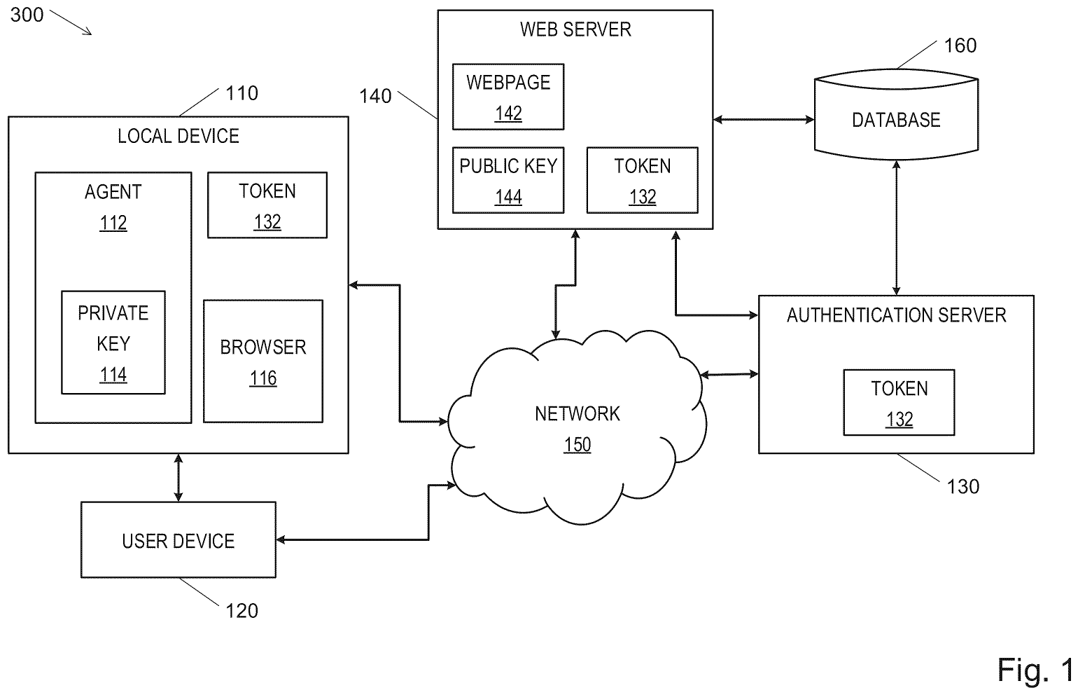

Reference is made to FIG. 1, which is a system 100 according to embodiments of the invention. According to some embodiments, local device 110, user device 120, authentication server 130 and web server 140 may include components of computing device 700. System 100 may include devices associated with a particular user such as local device 110 and user device 120. While FIG. 1 presents devices associated with a single user and a single web server 140, this is done for simplicity only and system 100 may include a plurality of devices associated with a plurality of users and a plurality of web servers 140.

Network 150 may include any type of network or combination of networks available for supporting communication between local device 110, authentication server 130 and web server 140, and other devices connected to network 150. Network 150 may include for example, a wired, wireless, fiber optic, or any other type of connection, a local area network (LAN), a virtual private network (VPN), a wide area network (WAN), the Internet and intranet networks, etc. According to some embodiments, authentication server 130 and web server 140 may have a direct link between them, or may be connected through a local or private network, e.g., a LAN or WAN networks.

Web or application server 140 may be a service or an application for delivering static content, such as webpages 142, images, videos, and files as well as dynamic content such as real-time updates, personalized information, and customer support.

Each of local device 110 and user device 120 may be a computing device associated with a user. Local device 110 may execute a user agent software or application, e.g., agent 112 and a browser application 116. Each of local device 110 and user device 120 may be connected to network 150. A user may initiate a request to open website or webpage 142, e.g., a request to download and display the website or webpage 142 on local device 110) through local device 110, e.g., using agent 112 and browser 116. As used herein webpage 142 may refer to a document on the Internet or web that is identified by a unique uniform resource locator (URL), e.g., a unique address on the web. Webpage 142 may be provided or operated by a server connected to network 150, e.g., web server 140. Webpage 142 may be access limited, e.g., protected by one or more factors such as a username, a password, MFA, e.g., fast identity online (FIDO), push notification, or other types of MFA, etc. Thus, a user may gain access to webpage 142 (e.g., download and present webpage 142) by providing the required factors.

In a successful phishing attack or following other types of attacks, an attacker may have possession of the factors required for opening webpage 142, e.g., the username, password, OTP, or may deceive the user to confirm authentication request by approving authentication factors, e.g. confirming a push authentication message or confirming the request via a FIDO token, etc. In some cases, the attacker may have the possession of one of more factors and deceive the user to confirm another one or more factors. Thus, in prior art systems, the attacker may gain access to webpage 142 despite not being the actual user. In many scenarios, the attacker may not have possession of local device 110 and/or user device 120, and may not try to access webpage 142 through local device 110 or agent 112, but through another computing system. According to embodiments of the invention, web server 140 may open webpage 142 only after obtaining a certain token 132 or other security data object from local device 110. Token or security data object 132 may be provided specially to local device 110 from authentication server 130, and may be sent directly from local device 110 to web server 140 during login with no involvement of the user. Thus, token 132 in some embodiments is never provided to the user and the user may not be required to provide token 132 during a legitimate login process. Therefore, the user may not be able to provide the token to an attacker. Thus, it may be assumed that the attacker may not get token 132 in the phishing attack, and thus may not be able to open webpage 142.

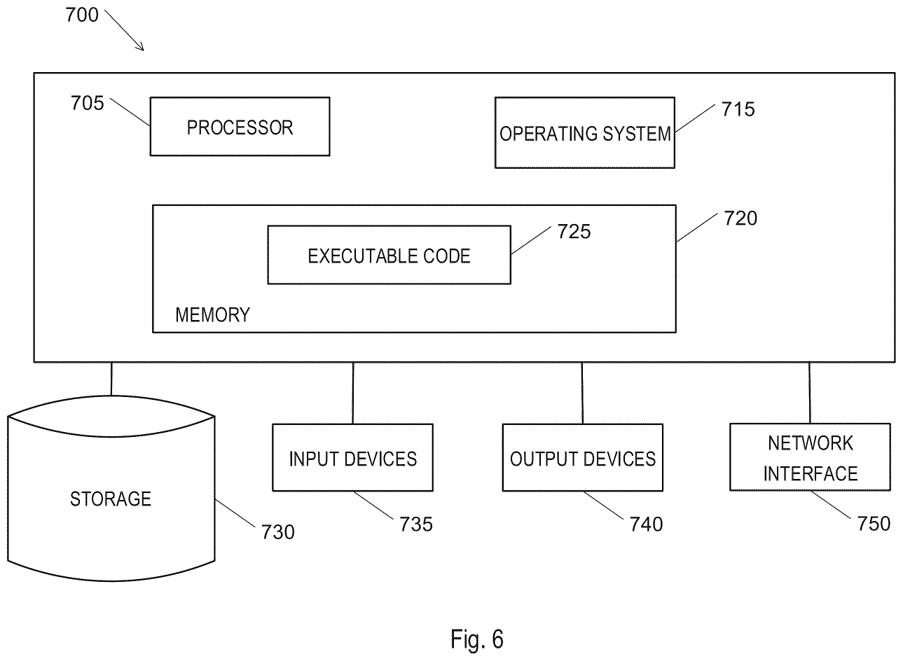

Database 160 may be a storage device (e.g., storage 730 depicted in FIG. 6) used for storing tokens and any other data, as required by the application.

User device 120 may be a device external to local device 110 (e.g., physically separated from local device 110) or internal to local device 110, that may be used to authenticate or verify an identity of the user. User device 120 may be or may include for example, a mobile smartphone operating an authentication application or an embedded biometric module with authentication capabilities (embedded for example in local device 110), e.g., an embedded fingerprint module. User device 120 may verify the identity of the user using any applicable method, e.g., using a pin code, or by performing biometric authentication using at least one of a fingerprint, a facial pattern, an iris pattern, a retinal pattern, voice authentication, etc. User device 120 may have a direct line of communication with local device, e.g., using Bluetooth Low Energy (BLE), universal serial bus (USB), Near Field Communication (NFC) etc.

According to embodiments of the invention, authentication server 130 may obtain or receive the request to open webpage 142 from agent 112. In response to obtaining the request to open webpage 142, authentication server 130 may generate a token 132, and provide or send the generated token 132 to both agent 112 and web server 140. Token 132 may be valid for a limited period, e.g., may be used for only a limited time from generation, after which token 132 expires, e.g., 1 minute, 2 minutes, etc. Token 132 may include data such as a random or non-random value, string, vector or other identifier associated with the request to open webpage 142. Authentication server 130 may send or provide token 132 (and optionally the time limit of token 132) to web server 140 directly, e.g., via a direct link between authentication server 130 and web server 140, via network 150, or by storing token 132 in a common or shared database, e.g., database 160, that may be connected to and accessible by both authentication server 130 web server 140.

Agent 112 may send token 132 obtained from authentication server 130 to web server 140. Thus, web server 140 may obtain two versions of token 132, one from authentication server 130 and one from agent 112. Web server 140 may verify token 132 obtained from agent 112 against token 132 obtained from authentication server 132, e.g., verify that token 132 obtained from agent 112 matches token 132 obtained from authentication server 132. For example, web server 140 may check that token 132 obtained from agent 112 equals or is identical to token 132 obtained from authentication server 132, or that a predetermined relation exists between token 132 obtained from agent 112 and token 132 obtained from authentication server 132. If the two tokens are identical or have the predetermined relation between them, or if other verification methods of token 132 obtained from agent 112 against token 132 obtained from authentication server 132 are successful, a successful or positive verification or simply “verification” may be established; the tokens are not identical, it may be considered that verification failed. Other verification methods may be used. Web server 140 may provide webpage 142 to agent 112, or may provide access to webpage 142 to agent 112, only if the verification of token 132 is successful. If the verification of token 132 is not successful or fails, e.g., if no token is obtained from agent 112 or if a wrong token (e.g., unmatching token) is obtained from agent 112, then web server 140 may not provide webpage 142 to agent 112 or may prevent access to webpage 142 from agent 112. Thus, access of an attacker that does not have possession of token 132 to webpage 142 may be denied and prevented.

According to some embodiments, agent 112 may sign token 132 prior to sending token 132 to web server 140 using a private key 114 owned by agent 112, and send the signed version of token 132 to web server 140. Web server 140 may verify the signed token obtained from agent 112 against token 132 obtained from authentication server 130 using a public key 144 corresponding to private key 114 (e.g., private key 114 and public key 144 may form a public-private key pair) to verify the signed token obtained from agent 112, or determine verification failed. This may provide a second level of protection against unauthorised access to webpage 142 since on top of not having access to token 132, the attacker may not have access to the private key as well.

According to some embodiments, authentication server 130 may authenticate the user prior to generating token 132 or prior to sending token 132 to agent 112, e.g., using MFA, FIDO, etc. For example, authentication server 130 may send a push notification to the user via user device 120, that may or may not include a second factor, such as an OTP, PIN code, biometric factor, etc. the user may confirm the push notification via inputting a confirmation to user device 120 and send the confirmation message to authentication server 130. The authentication server 130 may determine that the user is authenticated in response to obtaining the confirmation message from user device 120. Other methods and protocols may be used by authentication server 130 to authenticate the user.

In some implementations, local device 110 or agent 112 may operate a web browser 116 to provide webpage 142, as well as other portal applications to the user. Providing other portal applications may be performed in any applicable manner and using any relevant protocol, e.g., security assertion markup language single sign-on (SAML SSO). Thus, the user may be authenticated once and gain access to multiple applications. For example, providing other portal applications may include sending, from authentication server 130 to web browser 116, a single sign-on (SSO) token, using the SSO token to authenticate the user and opening the required portal application via web browser 116, upon successful verification of the SSO token.

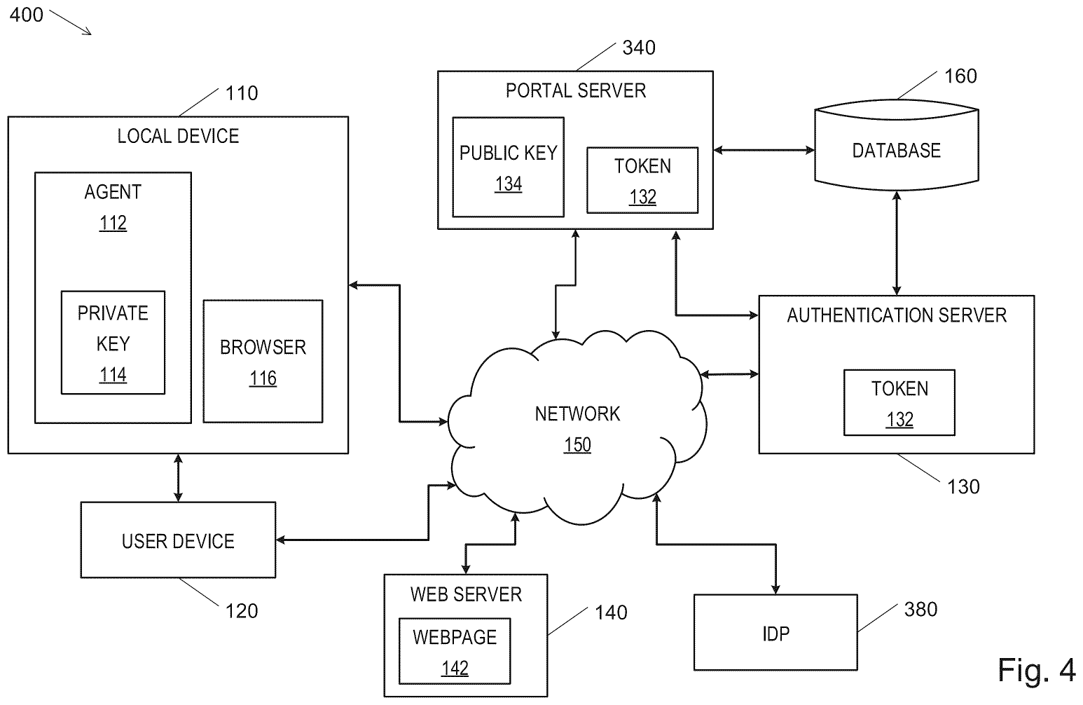

In some applications, providing other portal applications may include sending an SSO token from authentication server 130 to web browser 116, sending a request for executing a required portal application from web browser 116 to authentication server 130, sending the SSO token from web browser 116 to authentication server 130, authenticating the user by authentication server 130 using the SSO token, sending a corresponding URL for the required portal application, from authentication server 130 to web browser 116 upon successful verification of the user, sending from web browser 116 a request to open the URL to a server providing the required portal application, e.g., web server 140, forwarding the request to authentication service or identity provider (IdP), e.g., such as IdP 380 depicted in FIG. 4, verifying the SSO token by IdP 380, and opening the required portal application by web server 140 via web browser 116, upon successful verification of the SSO token.

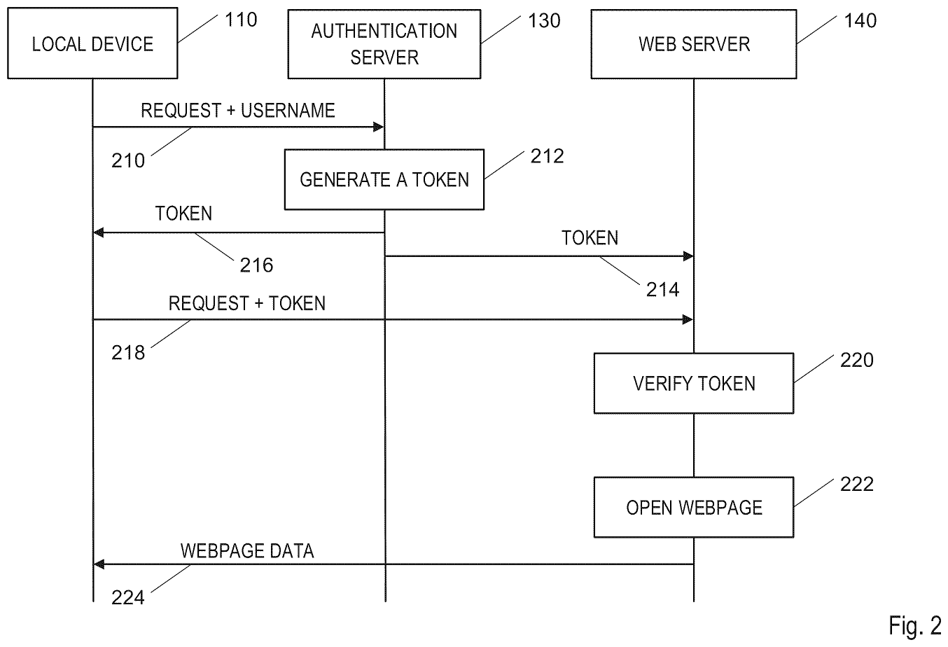

Reference is now made to FIG. 2 which is a flowchart of a method for providing a secure access to a webpage, according to embodiments of the invention. An embodiment of a method for providing a secure access to a webpage may be performed, for example, by the systems shown in FIGS. 1 and 6, or other systems.

In operation 210 a user agent application, e.g., agent 112 operated by local device 110, may send a request to open a webpage to authentication server 130 together with username or other ID, and password if required. The request to open the webpage may be obtained at local device 110 from a user and forwarded to authentication server 130. In operation 212, authentication server 130 may generate a token, e.g., a random or non-random value associated with the request to open webpage. The generated token may be valid for a limited period. In operation 214, authentication server 130 may share, provide or send the token (and optionally the time limit of token 132) to web server 140. In operation 214 the token may be shared between authentication server 130 and web server 140 via a shared or common database, e.g., database 160 that may be accessible by both authentication server 130 and web server 140, depicted in FIG. 1, or sent via network 150 or a direct link. In operation 216, authentication server 130 may provide or send the token to user agent application on local device 110. In operation 218, local device 110 may provide or send the token to web server 140, together with a request to open a webpage operated or provided by web server 140. In operation 220, web server 140 may verify the token obtained from local device 110 (e.g., from a user agent application operated by local device 110), against the token obtained from authentication server 130. Verifying the token may include comparing the two tokens or performing other operations to verify that the two tokens match, and optionally verifying that the token has not expired. In operation 222, web server 140 may, upon successful or positive verification of the token, open the required webpage, e.g., the webpage requested by the user agent application in operation 210. For example, web server 140 may enable the user agent application to download and present the webpage requested by the user agent application in operation 210. That is, if the token is not verified successfully, e.g., if no token is obtained from local device 110, or if the token obtained from local device 110 expired or does not match the token obtained from authentication server 130, then web server 140 may not open the required webpage, e.g., the web server 140 may prevent the user agent application from accessing the web page and may not enable the user agent application to download and present the webpage requested by the user agent application in operation 210. In operation 224, web server 140 may, again only upon successful verification of the token, send webpage data to local device 110, e.g., to a browser application operated by local device 110. If the token is not verified successfully in operation 220, web server 140 may not send webpage data to local device 110 or may not provide access to the webpage to local device 110.

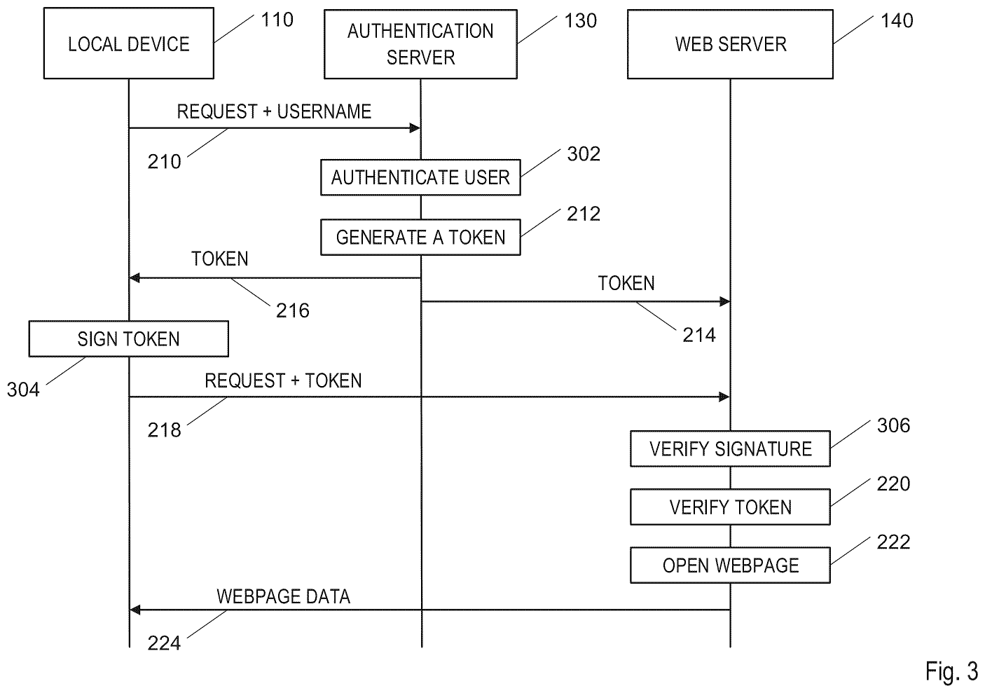

Reference is made to FIG. 3, which is a flowchart of a method for providing secure access to a webpage with added levels of protection, according to embodiments of the invention. An embodiment of a method for providing secure access to a webpage with added levels of protection may be performed, for example, by the systems shown in FIGS. 1 and 6, or other systems. Embodiments of the method for providing secure access to a webpage with added levels of protection may be similar to embodiments of performing providing secure access to a webpage, as presented in FIG. 2, with the added levels of security provided by authenticating the user and using a private-public key pair to protect the token. Similar operations will be given the same reference numerals.

In operation 302, authentication server 130 may authenticate the user prior to generating the token, e.g., using MFA such as FIDO, push notification, or other MFA types. Authenticating the user by authentication server 130 may include, in some embodiments, sending a push notification, that may or may not include a second factor, such as an OTP, PIN code, biometric factor, etc, an OTP, a FIDO token or another type of MFA, to the user via a user device, and obtaining a user confirmation by all required authentication factors, from the user device. Other methods for authenticating the user by authentication server 130 may be used. In case the authentication fails, the process may terminate at this point.

Additionally or alternatively, as presented in operation 304, local device 110 may sign the token using, for example, a private key, before sending a signed version of the token to web server 140 in operation 218. Web server 140 may verify the token signature, as indicated in operation 306, using for example, a public key corresponding to the private key used by local device 110 to sign the token. It is noted that some embodiments may only add certain levels of security, e.g., either authenticating the user (operation 302) or signing the token and verifying the signature of the token (operations 304-306), while other embodiments may implement both.

Reference is made to FIG. 4, which is a system 400 according to embodiments of the invention. Components in system 400 that are similar to components in system 100 are given the same reference numerals and will not be described in detail again. According to some embodiments, portal server 340, web server 370 and IdP 380 may include components of computing device 700.

Organizational portal server 340, also referred to herein simply as portal server 340, may be a gateway providing access through web browser 116 to business information, organization data, organization applications and webpages 142 located inside and outside of the organization, to members of the organization. According to embodiments of the invention, portal server 340 may provide secure access to webpage 142 using a token as disclosed herein.

According to embodiments of the invention, authentication server 130 may obtain or receive the request to open webpage 142 from agent 112. In response to obtaining the request to open webpage 142, authentication server 130 may generate a token 132, and provide or send the generated token 132 to both agent 112 and portal server 340. Token 132 may include a random or non-random value associated with the request to open webpage 142. Token 132 may be time limited, e.g., may expire after some time. Authentication server 130 may send token 132 (and optionally the time limit of token 132) to portal server 340 directly, e.g., via a direct link between authentication server 130 and portal server 340, via network 150, or by storing token 132 in database 160, that may be connected to portal server 340 as well.

Agent 112 may send token 132 obtained from authentication server 130 to portal server 340. Thus, portal server 340 may obtain two versions of token 132, one from authentication server 130 and one from agent 112. Portal server 1340 may verify token 132 obtained from agent 112 against token 132 obtained from authentication server 132 e.g., verify that token 132 obtained from agent 112 matches token 132 obtained from authentication server 132, and optionally verifying that the token has not expired. For example, portal server 340 may check that token 132 obtained from agent 112 equals or is identical to token 132 obtained from authentication server 132, or that a predetermined relation exists between token 132 obtained from agent 112 and token 132 obtained from authentication server 132.

Portal server 340 may provide webpage 142 to agent 112, or may provide access to webpage 142 to agent 112, only if the verification of token 132 is successful. Portal server 340 may utilize any applicable protocol to provide webpage 142 operated by web server 140 to browser 116. If the verification of token 132 is not successful, e.g., if no token is obtained from agent 112 or if a wrong or expired token (e.g., unmatching token) is obtained, then portal server 340 may utilize any applicable protocol to prevent web server 140 from providing webpage 142 to agent 112 or may prevent access to webpage 142 from agent 112. Thus, access of an attacker that does not have access to token 132 to webpage 142 may be prevented.

According to some embodiments, agent 112 may sign token 132 prior to sending token 132 to portal server 340 using a private key 114 owned by agent 112, and send the signed version of token 132 to portal server 340. Portal server 340 may verify the signed token obtained from agent 112 against token 132 obtained from authentication server 130 using a public key 144 corresponding to private key 114 to verify the signature of the signed token obtained from agent 112. This may provide a second level of protection against unauthorised access to webpage 142 since on top of not having access to token 132, the attacker may not have access to the private key as well.

According to some embodiments, authentication server 130 may authenticate the user prior to generating token 132 or prior to sending token 132 to agent 112, e.g., using MFA or FIDO. For example, authentication server 130 may send a push notification, e.g., including an OTP or a FIDO token, to the user via user device 120, the user may confirm the push notification via user device 120 and send the confirmation message, e.g., including the OTP or the FIDO token, to authentication server 130. The authentication server 130 may determine that the user is authenticated in response to obtaining the confirmation message from user device 120. Other methods and protocols may be used by authentication server 130 to authenticate the user.

In some implementations, local device 110 or agent 112 may operate a web browser 116 to provide webpage 142, as well as other portal applications to the user. For example, providing other portal applications may include sending, from a portal server (e.g., portal server 340 presented in FIG. 4) to web browser 116, a SSO token, using the SSO token to authenticate the user and opening the required portal application via web browser 116, upon successful verification of the SSO token.

In some applications, providing other portal applications may include sending an SSO token from the portal server to web browser 116, sending, with or without a request from the user, a request for executing a required portal application from web browser 116 to the portal server, sending the SSO token from web browser 116 to authentication server 130, authenticating the user by authentication server 130 using the SSO token, sending a corresponding URL for the required portal application, from authentication server 130 to web browser 116 upon successful verification of the user, sending from web browser 116 a request to open the URL to a server providing the required portal application, e.g., web server 140, forwarding the request to a verification service, verifying the SSO token by the verification service, and opening the required portal application by the server providing the required portal application via web browser 116, upon successful verification of the SSO token.

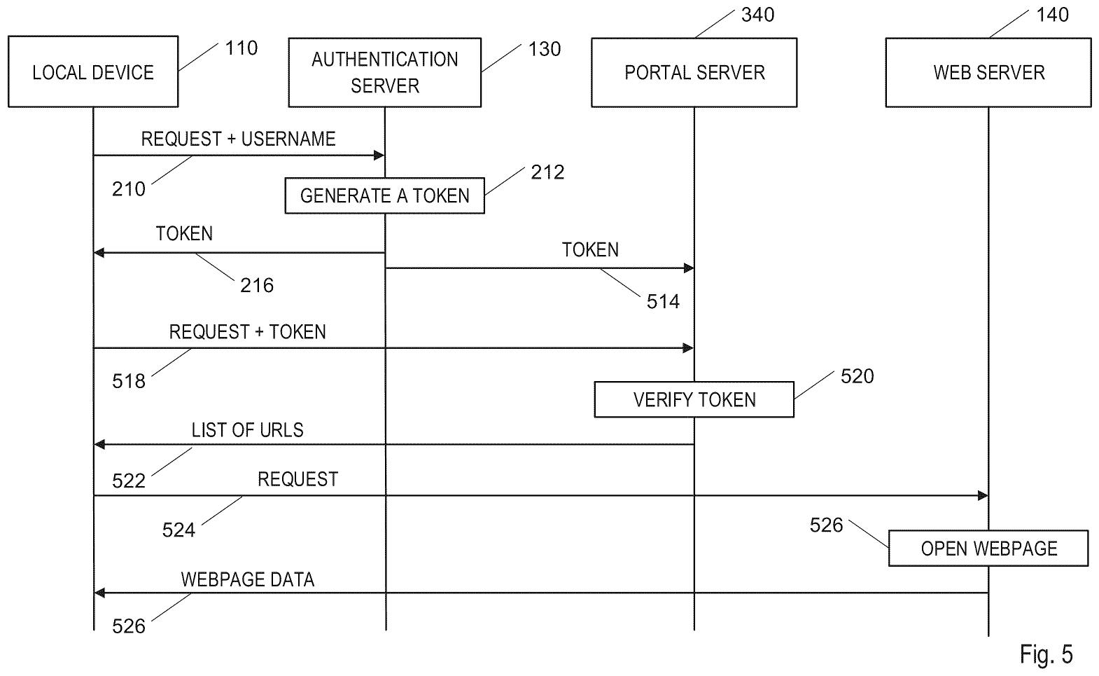

Reference is now made to FIG. 5 which is a flowchart of a method for providing a secure access to a webpage through a portal server, according to embodiments of the invention. An embodiment of a method for providing a secure access to a webpage through a portal server may be performed, for example, by the systems shown in FIGS. 1, 4 and 6, or other systems. Some operations in embodiments of the for providing a secure access to a webpage through a portal server depicted in FIG. 5 are similar to operations of embodiments of the method for performing providing a secure access to a webpage, as presented in FIG. 2; those operations will be given similar reference numerals.

In operation 210 a user agent application, e.g., agent 112 operated by local device 110 may send a request to open a webpage to authentication server 130 together with a user identifier, e.g., username. The request to open the webpage may be obtained in local device 110 from a user and forwarded to authentication server 130. In operation 212, authentication server 130 may generate a token, e.g., a random or non-random value associated with the request to open webpage. The generated token may be valid for a limited period. In operations 514, authentication server 130 may share, provide or send the token to portal server 340 (and optionally the time limit of token 132). In operation 514 the token may be shared between authentication server 130 and portal server 340 via a shared or common database, e.g., database 160 that may be accessible by both authentication server 130 and portal server 340, depicted in FIG. 4, or sent via network 150 or a direct link. In operation 216, authentication server 130 may provide or send the token to user agent application on local device 110. In operation 518, local device 110 may send the token to portal server 340, together with a request to open a webpage operated or provided by web server 140. In operation 520, portal server 340 may verify the token obtained from local device 110 (e.g., from a user agent application operated by local device 110), against the token obtained from authentication server 130. Verifying the token may include comparing the two tokens or performing other operations to verify that the two tokens match, and optionally verifying that the token has not expired. In operation 522, portal server 340 may, upon successful verification of the token, send a list of URLs to local device, e.g., to a browser application (e.g., browser 116) operated by local device 110. That is, if the token is not verified successfully, e.g., if no token is obtain from local device 110, or if the token obtained from local device 110 does not match the token obtained from authentication server 130, or if the token has expired, then portal server 340 may not send the list of URLs required to open the required webpages. In some embodiments, local device 110, e.g., a browser application operated by local device 110, may send a request to authentication server 130 with each URL, which may send in response the service URLs for web server 140. In operation 524, local device 110, e.g., a browser application operated by local device 110, may, again only upon successful verification of the token, send a request to each web server 140 that appears in each service URL. If the token is not verified successfully in operation 220, local device 110 may not send a request to any web server 140. In operation 526, web server 140 may open the webpage and in operation 528, web server 140 may provide webpage data to local device 110, e.g., to a browser application operated by local device 110. It is noted that more levels of protection may be provided, including authenticating the user and using a private-public key pair to protect the token.

For example, providing other portal applications may include sending, from a portal server (e.g., portal server 340 presented in FIG. 4) to web browser 116, an SSO token, using the SSO token to authenticate the user and opening the required portal application via web browser 116, upon successful verification of the SSO token.

In some applications, providing other portal applications (provided by portal server 34) and/or webpages (provided by webserver 140) may include sending an SSO token from portal server 340 to web browser 116, sending a request for executing a required portal applications and webpages from web browser 116 to portal server 340, sending, for each application or web page included in the response from portal server 340, the SSO token from web browser 116 to authentication server 130, authenticating the user by authentication server 130 using the SSO token, sending a corresponding URL for the required portal application and webpages, from authentication server 130 to local device 140 upon successful verification of the user by the SSO token, sending from local device 140 a request to open the URL to a server providing the required portal application, e.g., web server 140, forwarding the request to a verification service, verifying the SSO token by the verification service, and opening the required portal application by web server 140 providing the required portal application via web browser 116, upon successful verification of the SSO token. If verification of the SSO token is not successful, the process may terminate and the required portal application may not open.

FIG. 6 illustrates an example computing device according to an embodiment of the invention. Various components such as local device 110, user device 120, authentication service 130, web server 140 and other modules, may be or include, or be executed by, computing device 700, or may include components such as shown in FIG. 6. For example, a first computing device 700 with a first processor 705 may be used to provide secure access to webpages, according to embodiments of the invention.

Computing device 700 may include a processor 705 that may be, for example, a central processing unit processor (CPU), a chip or any suitable computing or computational device, an operating system 715, a memory 720, a storage 730, input devices 735 and output devices 740. Processor 705 may be or include one or more processors, etc., co-located or distributed. Computing device 700 may be for example a workstation or personal computer, or may be at least partially implemented by one or more remote servers (e.g., in the “cloud”).

Operating system 715 may be or may include any code segment designed and/or configured to perform tasks involving coordination, scheduling, arbitration, supervising, controlling or otherwise managing operation of computing device 700, for example. Operating system 715 may be a commercial operating system. Operating system 715 may be or may include any code segment designed and/or configured to provide a virtual machine, e.g., an emulation of a computer system. Memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 720 may be or may include a plurality of possibly different memory units.

Executable code 725 may be any executable code, e.g., an application, a program, a process, task or script. Executable code 725 may be executed by processor 705 possibly under control of operating system 715. For example, executable code 725 may be or include software for providing secure access to webpages, according to embodiments of the invention. In some embodiments, more than one computing device 700 may be used. For example, a plurality of computing devices that include components similar to those included in computing device 700 may be connected to a network and used as a system.

Storage 730 may be or may include, for example, a hard disk drive, a floppy disk drive, a Compact Disk (CD) drive, a CD-Recordable (CD-R) drive, a USB device or other suitable removable and/or fixed storage unit. Storage 730 may include or may store one or more database 160, In some embodiments, some of the components shown in FIG. 6 may be omitted. For example, memory 720 may be a non-volatile memory having the storage capacity of storage 730. Accordingly, although shown as a separate component, storage 730 may be embedded or included in memory 720. Database 160 may be at least partially implemented by one or more remote storage devices 730 (e.g., in the “cloud”).

Input devices 735 may be or may include a mouse, a keyboard, a touch screen or pad or any suitable input device. It will be recognized that any suitable number of input devices may be operatively connected to computing device 700 as shown by block 735. Output devices 740 may include one or more displays, speakers and/or any other suitable output devices. It will be recognized that any suitable number of output devices may be operatively connected to computing device 700 as shown by block 740. Any applicable input/output (I/O) devices may be connected to computing device 700 as shown by blocks 735 and 740. For example, a wired or wireless network interface card (NIC), a modem, printer or facsimile machine, a universal serial bus (USB) device or external hard drive may be included in input devices 735 and/or output devices 740. Network interface 750 may enable device 700 to communicate with one or more other computers or networks, e.g., network 150. For example, network interface 750 may include a Wi-Fi or Bluetooth device or connection, a connection to an intranet or the internet, an antenna etc.

Embodiments described in this disclosure may include the use of a special purpose or general-purpose computer including various computer hardware or software modules, as discussed in greater detail below.

Embodiments within the scope of this disclosure also include computer-readable media, or non-transitory computer storage medium, for carrying or having computer-executable instructions or data structures stored thereon. The instructions when executed may cause the processor to carry out embodiments of the invention. Such computer-readable media, or computer storage medium, can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computer” may be any computing system as previously defined herein, or any module or combination of modulates running on a computing system.

For the processes and/or methods disclosed, the functions performed in the processes and methods may be implemented in differing order as may be indicated by context. Furthermore, the outlined steps and operations are only provided as examples, and some of the steps and operations may be optional, combined into fewer steps and operations, or expanded into additional steps and operations.

The present disclosure is not to be limited in terms of the particular embodiments described in this application, which are intended as illustrations of various aspects. Many modifications and variations can be made without departing from its scope. Functionally equivalent methods and apparatuses within the scope of the disclosure, in addition to those enumerated, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used in this disclosure is for the purpose of describing particular embodiments only, and is not intended to be limiting.

This disclosure may sometimes illustrate different components contained within, or connected with, different other components. Such depicted architectures are merely exemplary, and many other architectures can be implemented which achieve the same or similar functionality.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

1. A computerized method for providing a secure access to a webpage, the method comprising:
obtaining, at an authentication server from a user agent application, a request to open the webpage provided by a web server, together with a username;
generating a token by the authentication server;
providing, by the authentication server, the token to the user agent application and to the web server;
sending, by the user agent application, a request to open the webpage together with the token to the web server;
verifying, by the web server, the token obtained from the user agent application against the token obtained from the authentication server; and
opening the webpage by the web server upon successful verification.

2. The method of claim 1, comprising signing the token by the user agent application using a private key owned by the user agent application prior to providing the token to the web server, wherein sending, by the user agent application, the token to the web server comprises sending the signed token, wherein the web server to verify the signed token obtained from the user agent application against the token obtained from the authentication server using a public key corresponding to the private key.

3. The method of claim 1, comprising authenticating the user by the authentication server prior to generating the token.

4. The method of claim 3, wherein authenticating the user by the authentication server comprises:
sending, by the authentication server, a push notification to the user via a user device; and
obtaining, at the authentication server, a user confirmation from the user device.

5. The method of claim 1, comprising operating a web browser by the user agent application.

6. The method of claim 5, comprising providing the webpage to the user through the web browser.

7. The method of claim 6, wherein providing the webpage comprises:
sending, by the authentication server to the web browser, a single sign-on (SSO) token;
using the SSO token to authenticate the user; and
opening the webpage via the web browser, upon successful verification of the SSO token.

8. The method of claim 6, wherein providing the webpage comprises:
sending, from the authentication server to the web browser, a single sign-on (SSO) token;
sending, from the web browser to the authentication server, a request for executing the webpage;
sending, from the web browser to the authentication server. the SSO token;
authenticating the user, by the authentication server, using the SSO token;
sending, from the authentication server to the web browser, a corresponding URL for the required webpage, upon successful verification of the user;
sending from the web browser, a request to open the URL to the web server;
forwarding the request to a verification service;
verifying the SSO token by the verification service; and
opening the webpage by the web server via the web browser, upon successful verification of the SSO token.

9. The method of claim 1, wherein the token is valid for a limited period.

10. A computerized method for providing a secure access to a webpage, the method comprising:
obtaining, in a user agent application, a request to open a webpage;
sending, by the user agent application, the request to open the web portal to an authentication server, together with a username;
generating a token by the authentication server;
sending, by the authentication server, the token to the user agent application;
sharing, by the authentication server, the token with a portal server;
signing the token by the user agent application using a private key owned by the user agent application;
sending, by the user agent application, the signed token together with an address of the webpage to the portal server;
verifying, by the portal server, the signed token against the shared token using a public key corresponding to the private key; and
opening the webpage by the portal server upon successful verification.

11. The method of claim 10, wherein sharing, by the authentication server, the token with a portal server comprises:
storing, by the authentication server, the token in a database common to the authentication server and to a portal server; and
reading, by the portal server, the token from the common database.

12. A system for providing a secure access to a webpage, the system comprising:
a web server;
a local device; and
an authentication server configured to:
obtain, from local device, a request to open the webpage provided by the web server, together with a username;
generate a token; and
provide the token to the local device and to the web server;
wherein the local device is configured to:
send a request to open the webpage together with the token to the web server;
wherein the web server is configured to:
verify the token obtained from the local device against the token obtained from the authentication server; and
open the webpage upon successful verification.

13. The system of claim 12, wherein the local device is configured to sign the token using a private key owned by the local device prior to providing the token to the web server, wherein the local device is configured to send the token to the web server by sending the signed token, wherein the web server is configured to verify the signed token obtained from the local device against the token obtained from the authentication server using a public key corresponding to the private key.

14. The system of claim 12, wherein the authentication server is configured to authenticate the user prior to generating the token.

15. The system of claim 14, wherein the authentication server is configured to authenticate the user by:
sending a push notification to the user via a user device; and
obtaining a user confirmation from the user device.

16. The system of claim 12, wherein the local device is configured to operate a web browser.

17. The system of claim 16, wherein the local device is configured to provide the webpage to the user through the web browser.

18. The system of claim 17, wherein the authentication server is configured to send a single sign-on (SSO) token to the web browser and use the SSO token to authenticate the user; and wherein the local device is configured to open the webpage via the web browser upon successful verification of the SSO token.

19. The system of claim 17, further comprising:
a verification service,
wherein the authentication server is configured to send a single sign-on (SSO) token to the web browser;
wherein the web browser is configured to send a request for executing the webpage and the SSO token to the authentication server;
wherein the authentication server is configured to authenticate the user using the SSO token and, to send to the web browser, upon successful verification of the user, a corresponding URL for the required webpage;
wherein the web browser is configured to send a request to open the URL to the web server;
wherein the web server is configured to forward the request to the verification service;
wherein the verification service is configured to verify the SSO token; and
wherein the web server is configured to open the webpage via the web browser, upon successful verification of the SSO token.

20. The system of claim 1, wherein the token is valid for a limited period.
